(19) United States
(12) Patent Application Publication
(10) Pub. No.: US 2010/0193494 A1
(43) Pub. Date: Aug. 5, 2010

(54) Conductive Compositions

(75) Inventors: Robert Prunchak, East Windsor, NJ (US); Francisco Vieira, Old Bridge, NJ (US); Xuerong Gao, Livingston, NJ (US); Virginia Garcia, Carteret, NJ (US)

Correspondence Address: BASF CATALYSTS LLC, 100 CAMPUS DRIVE, FLORHAM PARK, NJ, 07932, US

(73) Assignee: BASF Catalysts LLC, Florham Park, NJ (US)

(21) Appl. No.: 12/364,165

(22) Filed: Feb. 2, 2009

(51) Int. Cl. H05B 3/84; H01Q 1/38; H01B 1/22

(52) U.S. Cl. 219/203; 343/713; 252/514

(57) ABSTRACT

A conductive composition having a conductive component, a glass frit component, an organic medium, a boride component and a platinum group metal component, is provided. Embodiments of the conductive composition incorporate a palladium component and boride component selected from ZrB₂, TiB₂ and LaB₆ and combinations thereof and having a Mohs hardness of about 7 or greater. Embodiments of articles with a conductive composition disposed thereon and methods of preparing such articles are also provided.

### TECHNICAL FIELD

Embodiments of the present invention relate to conductive compositions, articles incorporating layers of conductive compositions and methods of preparing substrates having a conductive composition applied thereto.

### BACKGROUND

Conductive silver paste compositions are used on automotive glass to form bus bars, which function as antennae for radio reception and as electric heating systems for defogging and/or defrosting windows. The conductive layers formed from these compositions are subjected to abrasion or become cut or scratched. Such damage can interrupt or prevent the conductive layers from functioning properly and often occurs on rear windows found in sport utility vehicles, which can be raised or lowered to open and close. The conductive layers forming the bus bars and conductive lines on automotive glass can also be cut or scratched from removing stickers or other adhered material from the surface of the glass.

Damage to conductive layers can compromise radio reception and defogging capability. Accordingly, the industry is placing increased demand on conductive compositions which form conductive layers with enhanced abrasion resistance or cut and scratch resistance.

### SUMMARY

One or more aspects of the present invention pertain to compositions which include a conductive component, a glass frit component, an organic medium, and a boride powder component. In one or more embodiments, the composition also includes a platinum group metal (“PGM”) component.

In one or more embodiments, the conductive component is present in the range from about 50% to about 90%. In an alternative embodiment, the conductive component may be present in the range from about 55% by weight to about 80% by weight. In a specific embodiment, the conductive component is present in an amount in the range from about 60% by weight to about 75% and, in an more specific embodiment, the conductive component is present in the range from about 65% to about 70%.

The glass frit component utilized in accordance with one or more embodiments may be present in an amount in the range from about 0.1% to about 10% by weight. Alternative embodiments utilize a glass frit component in an amount in the range from about 2% by weight to about 7% by weight or 3% by weight to about 5% by weight. An organic medium may also be present in one or more embodiments in an amount in the range from about 9% to about 50% by weight. Optional embodiments may include an organic medium present in the range from about 15% to about 40% by weight.

The boride powder component utilized in one or more embodiments may be present in an amount in the range from about 0.01% to about 10% by weight or, alternatively, may be present in an amount in the range from about 0.05% to about 10% by weight. In a more specific embodiment, the boride powder component is utilized in an amount in the range from about 0.25% by weight to about 5 by weight and, in a more specific embodiment, the boride powder is present in an amount in the range from about 0.5% by weight to about 2% by weight.

Suitable boride powder components may have a Mohs hardness of about 7 or greater. Such components may include, without limitation, zirconium diboride, titanium diboride, lanthanum hexaboride, calcium hexaboride and combinations thereof. In one or more embodiments, the boride powder component includes ZrB₂, TiB₂, LaB₆ and/or combinations thereof. Such embodiments may further include additional boride powder components such as calcium hexaboride and strontium boride.

Embodiments which include a PGM component may also be substantially free of lead. In one or more such embodiments, the PGM component may be present in an amount in the range from about 0.01% to about 5% by weight. Optional embodiments may utilize a platinum group metal component in an amount in the range from about 0.25% to about 5% by weight or, more specifically, the PGM component is present in an amount in the range from about 0.1% by weight to about 0.5% by weight.

In one or more embodiments, the PGM component may include a platinum component, a palladium component, a rhodium component, an iridium component and/or combinations thereof. According to one or more specific embodiments, the PGM component includes a palladium components such as palladium based metallo-organics, palladium based resinates, silver-palladium alloys and/or combinations thereof.

Compositions according to alternative embodiments of the present invention may also include a mineral component or one or more additives. In one or more embodiments, suitable mineral components include andalusite, cordierite, corundum, forsterite, gahnite, sapphirine, sillimanite, spinel, quartz, mullite and/or combinations thereof. Additives utilized in such alternative embodiments may include zircon, zirconia, molybdenum silicide and combinations thereof. In one or more embodiments, zircon or zircon powders are present in an amount in the range from about 0.5% by weight to about 1% by weight. Compositions according to one or more specific embodiments may be substantially free of carbide and nitride powders.

A second aspect of the present invention includes an article. In accordance with one or more embodiments, the article includes automotive glass. In one or more specific embodiments, the article includes a first glass sheet and a second glass sheet. The first glass sheet may include an enamel composition disposed on one side of the first glass sheet, forming an enamel layer, and a conductive composition disposed on the enamel composition, forming a conductive layer. After heating the first glass sheet, the first glass sheet may be disposed on a second glass sheet and laminated in an autoclave as is know in the art. Such an embodiment incorporates a PVB (poly vinyl butyrate) interlayer as known in the art. In one or more specific embodiments, the article includes only a first glass sheet.

Suitable conductive compositions are described herein and may include a conductive component, a glass frit component, an organic medium, a boride powder component, as further described herein. In one or more embodiments, having a Mohs hardness of about 7 or greater and selected from the group consisting of ZrB₂, TiB₂ and LaB₆. A more specific embodiment of the article may utilize conductive compositions which include a platinum group metal component. Such embodiments may utilize a PGM component that includes a platinum component, a palladium component, a rhodium component, an iridium component and/or combinations thereof.

A third aspect of the present invention pertains to a method of preparing a substrate. Suitable substrates may include automotive glass. In one or more embodiments, the method includes applying a conductive composition to the substrate to form a conductive layer and heating the conductive layer to form a heated conductive layer. The conductive composition, according to one or more embodiments, may include a boride powder component and a platinum group metal component, as described herein. In a specific embodiment, the method includes applying a conductive composition to the substrate to form a conductive layer having a wet film thickness in the range from about 20 μm to about 40 μm.

In accordance with one or more embodiments, the method includes heating the conductive layer to form a heated conductive layer with a thickness in the range from about 8 μm to about 20 μm. In a specific embodiment, the conductive layer is heated to a temperature in the range from about 600° C. to 750° C. In a more specific embodiment, the conductive layer is heated to temperature in the range from about 600° C. to 750° C. for a duration in the range from about 2 minutes to 5 minutes. The heated conductive layer formed according to one or more methods described herein exhibits substantially constant electrical resistance. In one or more embodiments, the heated conductive layer exhibits less than 10% change in electrical resistance after application of an abrasion force of 500 g for 1000 revolutions.

In a specific embodiment, the method may include applying an enamel composition to the substrate to form an enamel layer before applying the conductive composition such that the conductive composition is thereafter applied to the enamel layer. In such embodiments, the enamel composition may be applied in a predetermined pattern on one side of the substrate.

### DETAILED DESCRIPTION

Before describing several exemplary embodiments of the invention, it is to be understood that the invention is not limited to the details of construction or process steps set forth in the following description. The invention is capable of other embodiments and of being practiced or being carried out in various ways.

One or more embodiments of the conductive composition include a boride powder component, a PGM component, a conductive component, a glass frit component and an organic medium. These components, along with other optional components, will now be discussed in detail.

One or more embodiments of the present invention include a boride powder component. The boride powder component of one or more embodiments is present in an amount in the range from about 0.01% by weight to about 10% by weight. In a specific embodiment, the boride powder component is present in an amount in the range from about 0.05% to about 10% by weight and, in a more specific embodiment, the boride powder component is present in an amount in the range from about 0.25% by weight to about 5 by weight. In one or more embodiments, the boride powder is present in an amount in the range from about 0.5% by weight to about 2% by weight. In one or more embodiments, the upper limit of the amount of the boride powder component may include 9%, 7%, 5% and 3% by weight and the lower limit of the amount of the boride powder component may include 0.05%, 0.1%, 0.25%, 0.5% and 1% by weight and all ranges and sub-ranges therebeteween.

According to one or more embodiments, suitable boride powders include those having a Mohs hardness value equal to or greater than about 7. Examples of such boride powders include zirconium diboride, titanium diboride, lanthanum hexaboride, calcium hexaboride and combinations thereof. According to one or more embodiments, the boride powder component includes one or more of ZrB₂, TiB₂ and LaB₆. Alternate embodiments include boride powders such as strontium boride.

One or more embodiments of the present invention include a PGM component. The PGM component of such embodiments is present in an amount in the range from about 0.01% by weight to about 5% by weight. In a specific embodiment, the PGM component is present in an amount in the range from about 0.25% to about 5% by weight and, in a more specific embodiment, the PGM component is present in an amount in the range from about 0.1% by weight to about 0.5% by weight. In one or more embodiments, the upper limit of the amount of the PGM component may include 4.5%, 4%, 3.5% and 3% by weight and the lower limit of the amount of the PGM component may include 0.05%, 0.1%, 0.25%, 0.5% and 1% by weight and all ranges and sub-ranges therebeteween.

Examples of suitable PGM components a platinum component, a palladium component, a rhodium component, an iridium component and combinations thereof. The PGM components may be present in one or more embodiments of the conductive composition in the form of powder, flakes, and/or whiskers. Specific examples of the palladium component may also include palladium-based metallo-organics or resinates. It is believed that these examples decompose during heating of firing of the conductive composition and become metal or oxide particles suspended within the sintered conductor or conductive layer. Alternate examples of palladium components also include silver-palladium alloys, or other PGM alloys.

The conductive component of one or more embodiments of the conductive composition may be present in an amount in the range from about 50% by weight to about 90% by weight. In a specific embodiment, the conductive component is present in an amount in the range from about 55% by weight to about 80% by weight, in a more specific embodiment, the conductive component is present in an amount in the range from about 60% by weight to about 75% and, in an even more specific embodiment, the conductive component is resent in the range from about 65% to about 70%. In one or more embodiments, the upper limit of the amount of the conductive component may include 85%, 80%, 78% and 75% by weight and the lower limit of the amount of the conductive component may include 55%, 60% and 65% by weight and all ranges and sub-ranges therebeteween.

The conductive component may include a conductive species such as, for example, silver, which may be present in powdered or particulate form. In embodiments utilizing silver, the silver particles can be spherical, flaked, or amorphous. In a more specific embodiment, the silver particles or a portion of the silver particles can be provided in a suspension of colloidal or nano particles. The silver species used in one or more embodiments can be in the form of fine powders of silver metal or silver alloys. In one or more specific embodiments, a portion of the conductive component includes silver oxide (Ag₂O), silver salts such as silver chloride (AgCl), silver nitrate (AgNO₃), silver acetate, silver resonates or silver metallo-organic compounds and/or combinations thereof. Other non-limiting examples of suitable conductive species include conductive metals such as gold, copper, platinum and palladium. These species may be present in the composition of one or more embodiments in powdered or particulate form.

The glass frit component of one or more embodiments is present in an amount in the range from about 0.1% to about 10% by weight. In a specific embodiment, the glass frit component is present in an amount in the range from about 2% by weight to about 7% by weight and, in a more specific embodiment, the glass frit component is present in an amount in the range from about 3% by weight to about 5% by weight. The upper limit of the amount of the glass frit component may include 9%, 8%, 7% and 6% by weight and the lower limit of the amount of the conductive component may include 0.5%, 1%, 2% and 3% by weight and all ranges and subranges therebeteween.

In one or more embodiments, the glass frit component may include a bismuth-based crystallizable glass frit. Specific embodiments may include Bi₂O₃, B₂O₃, SiO₂, and/or combinations thereof. In more specific embodiments, the glass frit component may include ZnO, CaO, SrO, BaO, and other additives known in the art. Alternative embodiments of the glass frit component may include TeO₂. It will be appreciated by one skilled in the art that other known frit components may also be utilized.

The organic medium is present in one or more embodiments of the in an amount in the range from about 9% to about 50% by weight. In a specific embodiment, the organic medium is present in an amount in the range from about 15% by weight to about 40% by weight. As the organic medium dissolves and disperses the conductive components and other components to form a conductive composition having suitable rheology, the amount and types of organic medium may be modified to achieve desired properties for use with different applications or methods of application.

In one or more embodiments, the organic medium includes any suitably inert solvent, resins and commonly used surfactants. Various organic mediums with or without thickening agents, stabilizing agents and/or other common additives are suitable for use in the preparation of the embodiments of the present invention. Examples of solvents include alcohols (including glycols) as well as esters of such alcohols, terpenes such as pine oil, terpineol and the like. More specific solvents include dibutyl phthalate, diethylene glycol monobutyl ether, terpineol, isopropanol, tridecanol and 2,2,4-trimethyl-1,3-pentanediol monoisobutyrate. Some embodiments utilize solvents that also contain volatile liquids to promote faster drying after application to a substrate.

Optional additives, which may be utilized in the conductive composition, include oxides and silicides. These additives include naturally occurring or synthetic minerals such as andalusite (Al₂OSiO₄), cordierite (Al₃(Mg,Fe)₂Si₅AlO₁₈), corundum (Al₂O₃), (Mg₂SiO₄), gahnite (ZnAl₂O₄), sapphirine ((Mg, Fe)₂Al₄O₆SiO4), sillimanite (Al₂OSiO₄), spinel (MgAl₂O₄), quartz (SiO₂), mullite, and combinations thereof. Alternate additives also include ceramics such as zirconia, molybdenum silicide and combinations thereof. One or more embodiments of the conductive composition may also include zircon. Such embodiments may include zircon in an amount in the range from about 0.5% to 1% by weight. In one or more embodiments, zircon powder is present in the amount between 0.25% by weight and 3% by weight.

According to one or more embodiments, the conductive composition is substantially free of zinc. In accordance with one or more embodiments, the conductive composition is substantially free of carbides and nitride powder. It is believed that carbides and nitride powders react with molten frit during heating or firing a layer formed from the conductive composition. This reaction is undesired and can lead to decomposition and “off-gassing” of the carbide or nitride powder that is used. Decomposition and off-gassing can greatly reduce the abrasion resistance because it can lead to a conductive layer having a porous microstructure.

A second aspect of the present invention includes articles which incorporate the conductive compositions described herein. For example, such articles may include a glass sheet with an enamel composition disposed thereon. The enamel composition may be disposed in a pre-determined thickness or pattern thickness on the glass sheet. The enamel composition may include a pigment, frit, organic vehicle, nucleating agents or other components known in the art. Articles according one or more embodiments also include a conductive layer formed on the enamel layer from a conductive composition, which may include a boride powder component and a PGM component. At least one embodiment of the present invention provides for application of a second glass sheet applied to the conductive layer. Such embodiments may also incorporate a PVB interlayer between the glass sheets of the article.

A third aspect of the present invention pertains to a method of preparing a substrate. The conductive compositions of the present invention can be applied to various substrates including, without limitation, automotive glass. In one or more embodiments, the method includes first applying an enamel composition to the substrate to form an enamel layer and then applying a conductive composition to the enamel layer to form a conductive layer. The method also includes heating the conductive layer to form a heated conductive layer. In one or more embodiments, the steps of drying the enamel layer before applying the conductive layer. Where the substrate is an automotive glass, optional steps may also include bending or shaping the glass. In such embodiments, the method of preparing a substrate may include multiple substrates.

In one or more embodiments, the enamel composition applied to the substrate may include a pigment, frit, organic medium or other components typically used in enamels. In such embodiments, the enamel composition may function as an obscuration enamel. According to one or more embodiments, the enamel composition is applied to the substrate in a pre-determined pattern or is applied to cover the entire substrate. Similarly, the conductive composition may also be applied in a pre-determined pattern on the enamel layer. The enamel composition may be applied by screen printing or other methods know in the art. Similarly, the conductive composition may also be applied by screen printing or other method known in the art and may also utilize a different application process than the enamel composition.

The conductive composition may be applied to form a conductive layer with a wet film thickness of about 10 μm to about 60 μm. In a specific embodiment, the conductive composition is applied to form a conductive layer with a thickness of about 15 μm to about 35 μm and, in a more specific embodiment, a thickness of about 20 μm to about 30 μm.

In one or more embodiments, the method includes firing the conductive layer at a temperature in the range from about 600° C. to 750° C. It will be appreciated by one skilled in the art that this temperature may be adjusted to sinter the particles of the conductive composition into grid lines or bus bars. In alternate embodiments, the firing step is carried out a temperature in the range from about 650° C. to 700° C. The upper limit of the firing temperature may include 740° C., 730° C., 720° C. and 710° C. and the lower limit of the firing temperature may include 610° C., 620° C., 630° C., and 640° C. and all ranges and subranges therebetween. The duration of the firing step of one or more embodiments is from about 2 minutes to about 5 minutes. Specific embodiments utilize a firing step with a duration of 3 minutes to 4 minutes.

According to one or more embodiments, the fired conductive layer can have a thickness in the range of about 5 μm to about 25 μm. In one or more embodiments, the fired conductive layer has a thickness in the range of about 8 μm to about 20 μm. In a specific embodiment, the fired conductive layer may have a thickness of 10 μm to 15 μm. In one or more embodiments, the upper limit of the thickness of the heated conductive layer may include 19 μm, 18 μm, 17 μm and 16 μm and the lower limit of the thickness may include 9 μm, 10 μm, 11 μm and 12 μm and all ranges and sub-ranges therebetween.

A conductive composition's durability or resistance to abrasion, scratches or cuts can be quantified by measuring the change in resistance of a conductive layer formed from the conductive composition. Changes in resistance are determined by testing the resistance of samples of conductive layers before and after application of abrasion forces. Such samples are prepared by printing a conductive composition onto an automotive glass with dimensions 100 mm×10 mm×3.8 mm in the pattern of an electrical circuit. The wet film thickness of the printed conductive layer is typically in the range of about 20μm to about 40μm. The printed automotive glass is then dried and heated to a peak temperature in the range from about 600° C. to 750° C. for a period of approximately 2 to 5 minutes. Depending on the components of the conductive composition, the heating step typically produces a conductive layer having a thickness in the range from about 8μm to about 20μm. The resistivity of this conductive layer is measured to determine an initial resistance level.

The automotive glass with the conductive layer printed thereon is then placed onto a Taber® Rotary Platform Abraser (herein after referred to as “Abraser”) and “abraded” to simulate abrasion typically endured by automotive glass. The Abraser is an instrument produced by Taber Industries and is sometimes referred to as a Rotary Platform Abrader or Rotary Platform Dual (Double) Head Tester. The Abraser includes two arms with an abrasive wheel or abrader wheel mounted to each arm and a rotating turntable, to which a sample is mounted. Reference to the term “abraded” means the process of applying the abrader wheels to the sample, with a specific pressure, as the sample is rotated by the turn table. The abrader wheels traverse a complete circle on the surface of the sample to test abrasion resistance at all angles relative to the weave or grain of the material. The weight of the arm or the pressure exerted on the sample and the number of revolutions can be varied and controlled. After being abraded on the Abraser, the electrical resistance of the sample is tested again and compared to the initial resistance measured before the sample was abraded.

Many automotive companies require that conductive layers formed from conductive paste compositions exhibit a change in resistivity of less than 15% after a being subjected to abrasion wear on the Abraser under arms with Model No. CS-10F abrader wheels and 500 g weight on each arm for 1000 revolutions. Model No. CS-10F abrader wheels are composed of aluminum oxide abrasive or silicon carbide particles and are available from Taber Industries, North Tonawanda, N.Y.

It should be appreciated by those skilled in the art that the method for preparing a substrate can be adjusted to produce a suitable fired conductive layer. For example, in one or more embodiments of the method of preparing a substrate, the fired conductive layer maintains electrical resistivity after being abraded or subjected to abrasion forces. In one embodiment, the electrical resistance of a fired conductive layer changes less than 10% after application of a rotational abrasion force of 500 g for a duration of up to 2000 revolutions. In a specific embodiment, the electrical resistance of heated conductive layer changes by less than 4% after application a rotational abrasion force of 500 g for 1000 revolutions. In a more specific embodiment, the heated conductive layer remains intact or maintains conductivity after application of a rotational abrasion force of 500 g for 3000 revolutions. In an even more specific embodiment, the electrical resistance of heated conductive layer changes by less than 16% after application a rotational abrasion force of 500 g for 3000 revolutions.

Without intending to limit the invention in any manner, embodiments of the present invention will be more fully described by the following examples.

### EXAMPLES

Eight conductive compositions (Compositions A-H) were prepared using conventional methods known in the art. The conductive ink according to one or more embodiments may be prepared by suitable equipment, such as a triple-roll mill. Conductive species, organic mediums, and any other additives can be mixed well using a variety of techniques known in the art such as planetary mixers and high speed dispersers and then further dispersed with a triple-roll mill. It is common that such pastes may require multiple passes over a triple roll mill in order to achieve the desired degree of dispersion. Alternative dispersion methods known in the art can be used as well. These include but are not limited to bead mills, sand mills, colloid mills, Kady mills and attritors.

Compositions A-H contained a conductive component, frit component, and an organic medium, as described otherwise in this application. Compositions C-H included additional components, as is shown in Table 1.

TABLE 1
Components of Compositions A-H by weight percent.

| | Frit | Conductive | Organic | | | | | |
|---|---|---|---|---|---|---|---|---|
| | Component | Component | Medium | ZrSiO₄ | ZrB₂ | TiB₂ | Pd | Total |
| Composition A | 3 | 78 | 19 | 0 | 0 | 0 | 0 | 100 |
| Composition B | 3 | 78 | 19 | 0 | 0 | 0 | 0 | 100 |
| Composition C | 3 | 78 | 18 | 1.0 | 0 | 0 | 0 | 100 |
| Composition D | 3 | 78 | 18.5 | 0.5 | 0 | 0 | 0 | 100 |
| Composition E | 3 | 78 | 18.5 | 0 | 0.5 | 0 | 0 | 100 |
| Composition F | 3 | 78 | 18 | 0 | 0 | 1.0 | 0 | 100 |
| Composition G | 3 | 78 | 18.5 | 0 | 0 | 0 | 0.5 | 100 |
| Composition H | 3 | 78 | 18.25 | 0 | 0 | 0.5 | 0.25 | 100 |

Compositions A-H were each screen printed using a 200 mesh screen on an automotive glass sheet measuring 100 mm×100 mm×3.8 mm. These parts were dried in a convection oven at ˜60 C for several minutes in order to remove the solvent. These dried parts were then fired to form a conductive layer in the pattern of an electric circuit, as described above, to produce Samples A-H, respectively.

The electrical resistance of each conductive layer was measured using a model 34410A multimeter produced by Agilent Technologies, Santa Clara, Calif. Each automotive glass sheet was then abraded using a Tabermodel 5130 Abraser using CS 10F wheels, as described above

The electrical resistance of Samples A-H was tested after each was abraded under a weight of 500 g on each arm for a total of 1000 revolutions. Afterwards, the CS-10F wheels were resurfaced as recommended by Taber Industries. Resurfacing involves replacing the test surface with an ST-11 Resurfacing Wheel (From Taber Industries) and running the abraser for 25 revolutions with the 500 g load. This resurfacing step acts to remove any accumulated dust (sample material) from the wheels, ensuring that the abrasive particles in the wheel are again exposed. The electrical resistance of Circuits A-H was measured again after each Sample had been abraded under a weight of 500 g for an additional 1000 revolutions, for a total of 2000 revolutions. The change in the electrical resistance of each Sample was calculated as shown below in Table 2.

TABLE 2
Percent Change in Electrical Resistance after 1000 revolutions
and 2000 revolutions.

| | After 1000 | After 2000 |
|---|---|---|
| | revolutions | revolutions |
| Composition A/Sample A | 11.87% | Line break |
| Composition B/Sample B | 8.32% | Line Break |
| Composition C/Sample C | 8.61% | 19.26% |
| Composition D/Sample D | 15.66% | 66.25% |
| Composition E/Sample E | 9.32% | 25.86% |
| Composition F/Sample F | 8.89% | 18.67% |
| Composition G/Sample G | 7.95% | 22.43% |
| Composition H/Sample H | 3.78% | 9.78% |

After again resurfacing the wheels as described in paragraph 39, samples F, G and H were further abraded for an additional 1000 revolutions. The electrical resistance of these Samples was tested and the percent change in resistance was calculated as shown below in Table 3.

TABLE 3
Percent Change in Electrical Resistance of Samples F, G
and H after 3000 revolutions.

| | After 3000 |
|---|---|
| | revolutions |
| Composition F/ | Line Break |
| Sample F | |
| Composition G/ | Line Break |
| Sample G | |
| Composition H/ | 15.70% |
| Sample H | |

A break in the conductive layer of a Sample, as a result of abrasion, is indicated as “line break.” Such disruption interrupts conductivity of the conductive layer. As shown in Tables 2 and 3, Samples E-H made from Compositions E-H exhibited a reduced change in resistivity than Samples A-D made from Compositions A-D. Further, Sample H, made from Composition H, which includes the addition of a boride powder component and a PGM component, withstood abrasion at 3000 revolutions without any breaks in the conductive layer.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments.

Although the invention herein has been described with reference to particular embodiments, it is to be understood that these embodiments are merely illustrative of the principles and applications of the present invention. It will be apparent to those skilled in the art that various modifications and variations can be made to the method and apparatus of the present invention without departing from the spirit and scope of the invention. Thus, it is intended that the present invention include modifications and variations that are within the scope of the appended claims and their equivalents.

What is claimed is:

1. A composition comprising:
a conductive component in an amount in the range from about 50% to about 90% by weight;
a glass frit component in an amount in the range from about 0.1% to about 10% by weight;
an organic medium in an amount in the range from about 9% to about 50% by weight;
a boride powder component selected from the group consisting of ZrB₂, TiB₂, LaB₆, and combinations thereof, having a Mohs hardness of about 7 or greater in an amount in the range from about 0.01% to about 10% by weight; and
a platinum group metal component in an amount in the range from about 0.01% to about 5% by weight, the composition being substantially free of lead.

2. The composition of claim 1, wherein the platinum group metal component is selected from a platinum component, a palladium component, a rhodium component, an iridium component and combinations thereof.

3. The composition of claim 1, wherein the platinum group metal component comprises a palladium component.

4. The composition of claim 3, wherein the palladium component is selected from palladium based metallo-organics, palladium based resinates, silver-palladium alloys and combinations thereof.

5. The composition of claim 1 further comprising a mineral component selected from andalusite, cordierite, corundum, forsterite, gahnite, sapphirine, sillimanite, spinel, quartz, mullite and combinations thereof.

6. The composition of claim 1, further comprising an additive selected from zircon, zirconia, molybdenum silicide and combinations thereof.

7. The composition of claim 1, further comprising calcium hexaboride and strontium boride.

8. The composition of claim 1, wherein the composition is substantially free of carbide and nitride powders.

9. The composition of claim 1 further comprising zircon in an amount from about 0.5% by weight to about 1% by weight.

10. The composition of claim 3, wherein the boride powder component is present in an amount in the range from about 0.05% to about 10% by weight and the palladium component is present in an amount in the range from about 0.25% to about 5% by weight.

11. An article comprising:
a first glass sheet;
an enamel composition disposed on the first glass sheet to form an enamel layer; and
a conductive composition disposed on the enamel layer to form a conductive layer, the conductive composition being substantially free of lead and comprising a conductive component, a glass frit component, an organic medium, a boride powder component having a Mohs hardness of about 7 or greater and selected from the group consisting of ZrB₂, TiB₂ and LaB₆, and a platinum group metal component.

12. The article of claim 11, wherein the conductive component is present in the range from about 50% to about 90% by weight;
the glass frit component is present in an amount in the range from about 0.1% to about 10% by weight;
the organic medium is present in an amount in the range from about 9% to about 50% by weight;
the boride powder component is present in an amount in the range from about 0.01% to about 10% by weight; and
the platinum group metal component is present in an amount in the range from about 0.01% to about 5% by weight.

13. The article of claim 11, wherein the platinum group metal is selected from a platinum component, a palladium component, a rhodium component, an iridium component and combinations thereof.

14. A method of preparing a substrate comprising:
applying a conductive composition to the substrate to form a conductive layer, the conductive composition comprising a boride powder component selected from the group consisting of ZrB₂, TiB₂, LaB₆, and combinations thereof, having a Mohs hardness of about 7 or greater, and a platinum group metal component, the conductive layer having a wet film thickness in the range from about 20 μm to about 40 μm;
heating the conductive layer to form a heated conductive layer having a thickness in the range from about 8 μm to about 20 μm.

15. The method of claim 14, wherein the conductive layer is heated to a temperature in the range from about 600° C. to 750° C. for a duration in the range from about 2 minutes to 5 minutes.

16. The method of claim 14, wherein the heated conductive layer comprises substantially constant electrical resistance such that applying an abrasion force of 500 g for 1000 revolutions results in less a than 10% change in the electrical resistance of the heated conductive layer.

17. The method of claim 14, wherein the platinum group metal is selected from a platinum component, a palladium component, a rhodium component, an iridium component and combinations thereof.

18. The method of claim 14, further comprising applying an enamel composition to the substrate to form an enamel layer, wherein the conductive composition is applied to the enamel layer.

19. The method of claim 18, wherein the enamel composition is applied in a predetermined pattern on one side of the substrate.

20. The method of claim 14, wherein the substrate is automotive glass.
